(19) United States
(12) Patent Application Publication
(10) Pub. No.: US 2018/0139273 A1
(43) Pub. Date: May 17, 2018

(54) ENTITY BASED ROUTING

(71) Applicant: LinkedIn Corporation, Sunnyvale, CA (US)

(72) Inventors: Qi Liu, Saratoga, CA (US); Joseph Florencio, San Jose, CA (US); Timothy Jack Showalter, Newark, CA (US); Alan Choi, San Francisco, CA (US); Rongsheng Liang, Cupertino, CA (US); Hailin Wu, Sunnyvale, CA (US); Hao Liu, Sunnyvale, CA (US); Jianhong Fang, Milpitas, CA (US); Xiao Bao, Mountain View, CA (US); Mihir Gandhi, Sunnyvale, CA (US); Yiwen Sun, Santa Clara, CA (US)

(21) Appl. No.: 15/351,028

(22) Filed: Nov. 14, 2016

(51) Int. Cl. H04L 29/08; H04L 12/721; H04L 12/733

(52) U.S. Cl. CPC H04L 67/1025; H04L 45/126; H04L 67/1021; H04L 45/72

(57) ABSTRACT

In some embodiments, the disclosed subject matter involves an entity routing service to route user requests for an application service to a particular data center based on the user's entity status. The user's entity status is defined by at least the application service requested, and may include the user's organization, geographic area and other criteria. The routing may be effected at the frontend application server level rather than at the backend. Other embodiments are described and claimed.

### TECHNICAL FIELD

An embodiment of the present subject matter relates generally to Internet accessible services, and more specifically, to routing communications based on a user's entity's status.

### BACKGROUND

Many Internet or network based data and services may be accessible to a user. The service may provide multiple data or service centers that are geographically diverse. Various mechanisms exist for routing a user to a specific location for data and services. In some cases, the routing is transparent to the user. In other cases, the user may select a specific site from which to download data, for instance. Existing systems may use a simple algorithm to determine where, geographically, a request originates, and then routes communication to a geographically proximate server, or data center.

In cases where the user is required to login to access the data or service, a specific server or data center may be selected based on the user's account characteristics. In some applications, data may be mirrored at more than one data center. In this case, there is no guarantee that access to data by multiple users will be efficient when users are routed to different data centers merely based on geographical proximity. A number of hops between data centers to update new data and ensure consistency may result in delays and undue network traffic.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating a relationship among users, entities and providers, according to an embodiment.

FIG. 2 is a block diagram illustrating proxy based network routing.

FIG. 3 is a block diagram, illustrating entity-based routing, according to an embodiment.

FIG. 4 is a block diagram, illustrating assignment of accounts to data centers, according to an embodiment.

FIG. 5 is a block diagram illustrating how buckets or entities are assigned to data centers, according to an embodiment.

FIG. 6 is a flow diagram for entity routing, according to an embodiment.

FIG. 7 is a block diagram illustrating an example of a machine upon which one or more embodiments may be implemented

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

An embodiment of the present subject matter is a system and method relating to routing users to a specific data center or server, based on the user's entity status. This concept may be referred to herein as “entity-based routing,” for simplicity. In at least one embodiment, services and data are made available to users via one or more servers, the servers typically residing in one or more distinct data centers. Some common or public data may reside on a point of presence (POP) server that may or may not be co-located with a data center. A provider may have more POP servers than data centers. A user may be a stand-alone entity, having access to only the user's personal data or services. A user may be a part of an enterprise, account or company to use data and services shared by other members of that entity. In some cases, members of an entity may share a subset of data and services. For instance, a network provider may provide multiple services to an entity. Members of the entity may be conceptually segregated into sub-entities, where each sub-entity utilizes a provider's service and shares data with other members of the sub-entity. Often entities contract with the provider for multiple services, via an “account,” where different services may be accessible by different members of their team, or enterprise. A user may be a member of multiple entities and sub-entities.

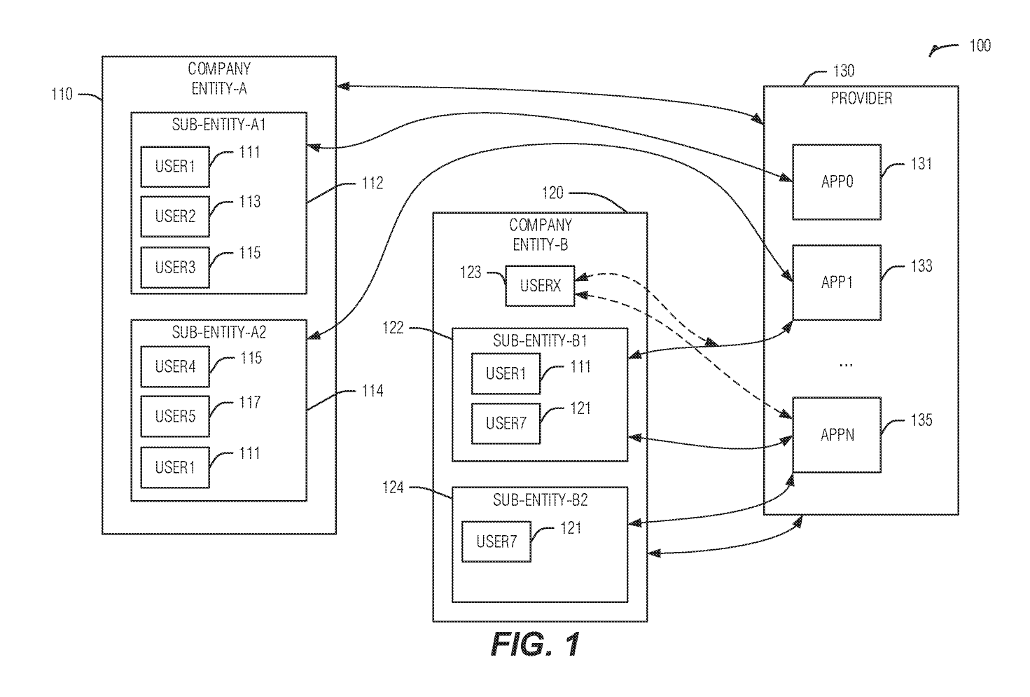

To illustrate, refer to FIG. 1, where an example entity-based paradigm 100 is shown in a block diagram. In an example, provider 130 may provide applications, or services and data, 131, 133 and 135. Users may require access to the applications, where the users may be associated with companies 110 and 120. In an example, company 110 is defined as Entity-A, and company 120 is defined as Entity-B. Entity-A 110 may require the use of applications and data APP0 131 and APPI 133. But not all users associated with Entity-A may require access, or be permitted access to both APP0 131 and APPI 133. In an example, access by Entity-A 110 is divided into sub-entities, Sub-Entity-A1 112 and Sub-Entity-A2 114. In this examples, Sub-Entity-A1 112 has user1 111, user2 113 and user3 115 as members. Sub-Entity-A2 114 has user1 111, user4 115 and user5 117 as members. In this example, access by Entity-B 120 is divided into sub-entities, Sub-Entity-B1 122 and Sub-Entity-B2 124. In this examples, Sub-Entity-B1 122 has user1 111 and user7 121 as members. Sub-Entity-B2 124 has user7 121 as its only member. It should be noted that user1 111 is a member in more than one entity. In an embodiment, user1 111 may be a contractor to both entities 110 and 120, or an employee of both entities. Other relationships between user1 and the individual entities may exist. In this example, userx 123 may be associated with Entity-B 120 as a whole, similar to a super user, and have access to all applications for which Entity-B 120 has contracted with Provider 130 (APP0 133 and APPN 135).

In an embodiment, Entity-A 110 and Entity-B contract with Provider 130 for access to various applications and services. The contracts may provide access requirement information regarding users and sub-entities. For instance, at the time of contract, Entity-A 110 may define APP0 and APPI are required, but that a different set of users will have access. Thus, sub-entities A1 112 and A2 114 are defined. In an alternative embodiment, Provider 130 may define the sub-entities dynamically, based on a number of variables. In an example, the sub-entities may map to individual application usage. In another embodiment, the sub-entities may be defined based on application, access-level (i.e., read/write vs. read/write/delete vs. read-only, etc.). In another embodiment the sub-entities may include the user or entity's geographic location, as a parameter. In an embodiment, a contract ID associated with the user and associated entity may be stored in a cookie. This cookie may be retrieved by the routing service to assist in routing user/entity service requests. A user may be associated with multiple cookies based on which services and data are requested at a given time, e.g., a user will have a different cookie for each entity or sub-entity to which the user has membership. While the term sub-entity has been used in this discussion, for illustrative purposes, the term “entity” may be used synonymously, for simplicity.

Some providers mirror their applications, or services, and data at multiple locations or data centers. This provides proximity efficiency for users who are able to access the service or data at a proximate location. However, when multiple users share data or a service, they may not be co-located. For instance, if an entity has users located in disperse geographical areas, existing routing systems might route individual user access to a different data center, most proximate to that user's location.

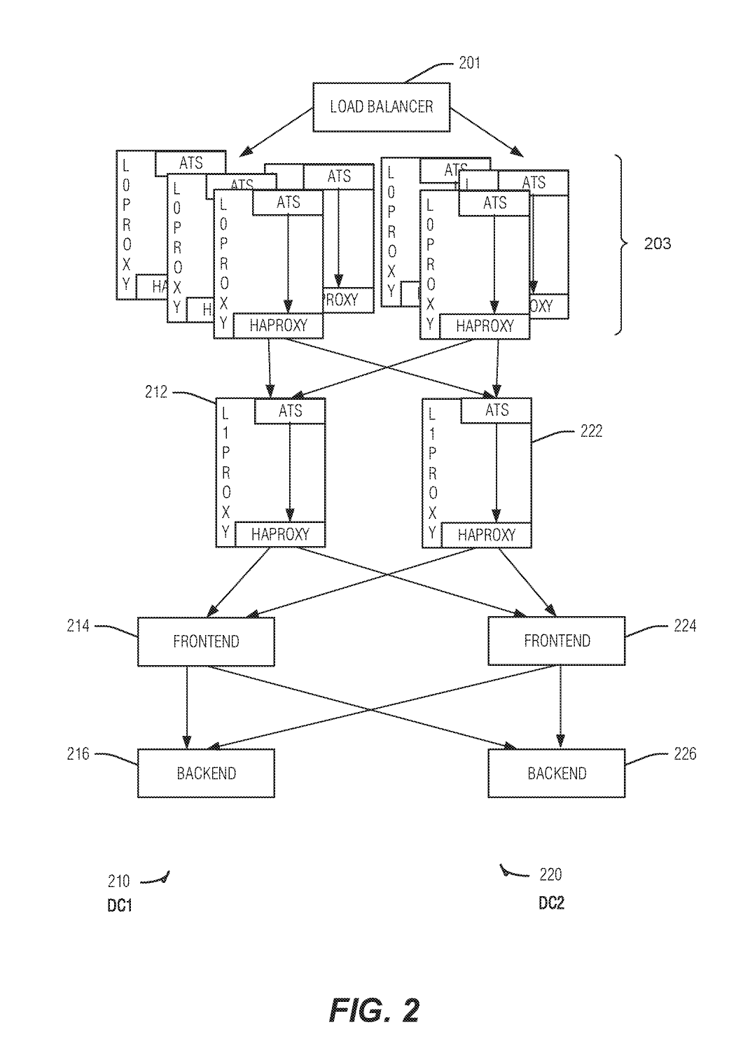

FIG. 2 is a block diagram illustrating a simple proxy routing scheme. A user may request a service from a provider by attempting open access to, or logging on to a domain accessible via a URL on the Internet. The provider may have several points of presence (POP) servers 203 and a number of data centers available. Thus, the provider may want to balance the load of Internet traffic at 201. The load balance may merely use a round robin technique for Internet requests or use a more complicated algorithm that takes proximity or application hosting into account. The POP servers 203 may host public or commonly used data such as news images at the POP server level for ease of retrieval. The L0 proxy server may use an Apache Traffic Server (ATS) component to implement the proxy server. The L0 proxy server may also include a high availability (HA) proxy component to load balance the TCP service. When a user requests access to a specific application, the request is often sent from the POP server using an L0 proxy server 203 to an L1 proxy server 212, 222 at a data center. The data center (DC1 and DC2) 210 and 220 may be selected by geography or other selection means. In some cases, an application may be available only from a specific data center. The L1 proxy server forwards the service request to a frontend server 214 or 224. In an example, a request from a user is forwarded from L1 212 to frontend 214 in DC1 210. If the data is hosted at a different data center DC2 220, then the frontend 214 must communicate with backend 226 in DC2 to service the request. Even if the request seems like a simple one call request, the frontend and backend may need many back and forth messages to complete the request. In this example, since frontend 214 and backend 226 are in two geographically disperse data centers, this communication may introduce unacceptable delays and inefficiencies. A more efficient traffic routing would have frontend 214 communicate mostly with backend 216, and for frontend 224 to communicate mostly with backend 226, thus keeping traffic within the same data center for a single request. This routing may be impossible when data is not hosted in the data center that tries to service the initial user request. It may be impractical for a request to be completely serviced in the same data center for other load balancing reasons, as well.

It will be understood that users requesting access to the same data may themselves be geographically disperse and initially routed to different data centers to service similar requests. It may be more efficient if users required to share data can share the data at the same location, or data center. This minimizes network hopping to access, retrieve, and update the most recent data. It will be understood that even when multiple data centers mirror data and services that there will be delays in synchronizing the data across data centers as users update or modify the data at one center. Thus, delays are minimized when users access data from the same center.

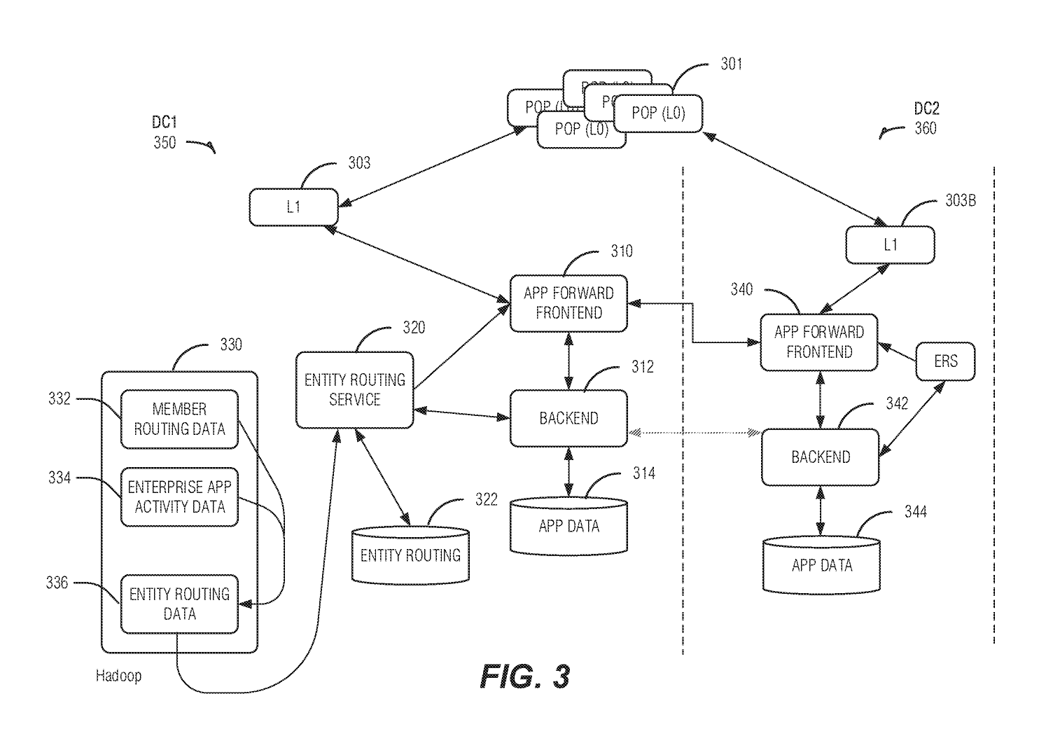

FIG. 3 is a block diagram illustrating an entity routing service, according to an embodiment. In an example, a provider may utilize multiple data centers, DC1 350 and DC2 360 to provide data and services to users, entities and sub-entities. It will be understood that more than two data centers may be available, and the two data centers are illustrated for purpose of simpler explanation. These data centers may also communicate with POP servers 301. A POP server may receive an initial service request from a user, and route it to one of the data centers. In existing systems, when a user requests data or services from a provider, the user may navigate directly to a URL, or login to the service. In an example system, a user may be automatically connected to a data center which is geographical proximate to the user's location. For instance, a user connects to the frontend architecture of the data center, perhaps a user profile page. The service returning this page must ultimately produce HTML, but the internal computations may use any convenient internal format. In an embodiment, internal components return JSON (JavaScript Object Notation) data for different sections of the page, then use an additional program to turn JSON into HTML. JSON is a lightweight data-interchange format. JSON formatted text is both easy for humans to read and write, and for machines to parse and generate; JSON is based on a subset of the JavaScript Programming Language. A system may asynchronously fetch and aggregate the data for this page. The server may produce HTML from several JSON data using a template. This technique is widely-known as “server-side rendering.” Alternatively, templates may render the HTML based on JSON data within the user's browser. Instead of using JSPs (Java Server Page) on the server and returning HTML directly to the browser, the Profile web app may serve the data for the page as JSON, then have the browser produce HTML from the JSON and JavaScript code. This technique is widely-known and called “client side rendering.” However, while this technique may make page rendering more efficient for a user, for many applications the user may still require access to data that may be hosted in a data center to which the user is not initially connected.

In an example, user1 111 may require access to data in APP0 131 which has been saved by user2 113. User2 113 may have been connected to data center, DC1 360, which is where that data may officially be hosted at App Data store 344, for the user's entity. In some embodiments, the data may be mirrored in both DC1 350 DC2 360 at App data stores 314 and 344. But the provider may designate DC1 350 as its primary location for the data, for a given entity. If user2 113 accesses the service but is connected with DC2 360, inefficiencies or incorrectness may result in passing the data back and forth between the data centers during usage. Existing systems typically route network traffic back and forth among data centers from the frontend 310 to backend 342 or frontend 340 to backend 312, as discussed in reference to FIG. 2. But this diagonal communication causes excess network traffic.

It should be noted that servers, elements and components shown for DC1 350 also reside in DC2 360. Some elements may be omitted in the figure so as not to obfuscate the discussion. In an embodiment, an entity routing service 320 is utilized to route the users and entities to an appropriate data center. A data store 322 (entity routing database) holds information relating to routing of a user based on the user's entity status. A user request may be received at a POP server 301 and then be routed to an L1 proxy 303 in DC1 350, based on the user's geographic proximity to DC1 350. Similarly, the request might be sent to L1 proxy server 303B at DC2 360. The request at L1 303 may be proxied to an application forward frontend 310. The frontend 310 uses the entity routing service, or agent, 320 to determine which backend application server should service the request 312 or 342. In an embodiment, the entity routing service identifies the entity of the user based on a cookie sent with the request. The entity routine service 320 consults the data store 322 to determine which backend server at which data center should service the request and forwards this information to the frontend 310. If, in an example, the entity is to be serviced in DC1 350, then the request is sent to backend 312, which uses application data stored at 314. In another example the entity routing service identifies that user request is to be serviced in DC2 360, then this information is sent to the frontend 310. In this case, the request is sent from the frontend 310 to the frontend 340 in DC2 360. Thus, the request is still formatted as the initial request from the user. Frontend 340 may then forward the request to backend 342, within the same data center, for servicing. Backend 342 communicates with application data at 344. In an example, the entire request is then handled by the same data center, minimizing excess network traffic, and the results are sent from frontend 340 to frontend 310 to be forwarded back to the user.

In some instances, certain backend requests may require servicing at different data centers. These requests may not have routing information, such as internal requests for maintenance events that do not come directly from an end user. Such requests do not carry cookie data and will not have routing information. In this case, the backend must consult the entity routing service to identify that it needs to forward information directly from backend 312 to backend 342, in an example.

A provider may change the routing information in data store 322 on a periodic basis dependent on factors such as changes in contracting entities, network traffic, bandwidth, load at the data centers, etc. In an embodiment, a Hadoop or Apache Traffic Server or agent 330 may be executed to retrieve and analyze load balancing, network, and entity usages, to be discussed more fully below. The agent 330 may retrieve member routing data 332 to determine where entities and users are (geographically) and which users or entities request services more often, etc., and collects data on specific member routing to and through the providers network or POP and data centers. The agent may also utilize an enterprise application activity service to identify which enterprise applications are more heavily used, and by which users and entities, and from which geographic areas and collects this data into the enterprise application activity data store 334. The results from these processes in 332 and 334 may be aggregated and analyzed by an entity routing data process 336 which feeds the results of its analysis to the entity routing service 320. If changes in routing need to be implemented, based on this analysis, the new routing associations are stored in entity routing data store 322.

In prior systems, making changes to routing relationships was a manual task and required several levels of changes, including reconfiguration of frontend and backend processes. These tasks could take hours to implement, causing significant downtime in user access to application services. In embodiments described herein, changing routing relationships using the entity routing service and entity routing database may reduce the downtime to a matter of minutes, rather than hours. The traffic analysis, member geographical preferences and load balancing are initiated and run by agents during maintenance events. Data and entity routing information is typically mirrored across data centers. An application service may also be available at each data center where members of the same entity will be routed to the same data center for processing. When the load balancing analysis indicates that an entity should be hosted at a different data center to obtain a more even load distribution, the entity routing data base is updated accordingly. Once the data in the application data stores and entity routing databases are propagated across data centers and guaranteed to be consistent and up to date, new user requests for the application service are routed to the hosting data center, for the entity.

Personal data routing may be a solution for some users. For example, each users' address book data for instance may be replicated in two different data centers but not all of the data centers. Read/write access for a user may be routed to only one data center. The entity routing service 320 may route a user to a different data center based on which application that user is accessing. A user, or member, may have specific routing data stored as member routing data. The users' routing data may define which data center should be accessed based on various member parameters, for instance geo location, or application access, or the users' entity or sub-entity status as described in FIG. 1. The routing for a specific entity may be stored at 322. So, when a user accesses data or a service where data is shared among team members, routing may be based on the entity specifics rather than the data specifics. For instance, if a user is accessing an individual profile, that user may be routed based only on member routing data. But when the same user accesses a service shared with entity team members, the access may be routed based on the entity routing data in 322.

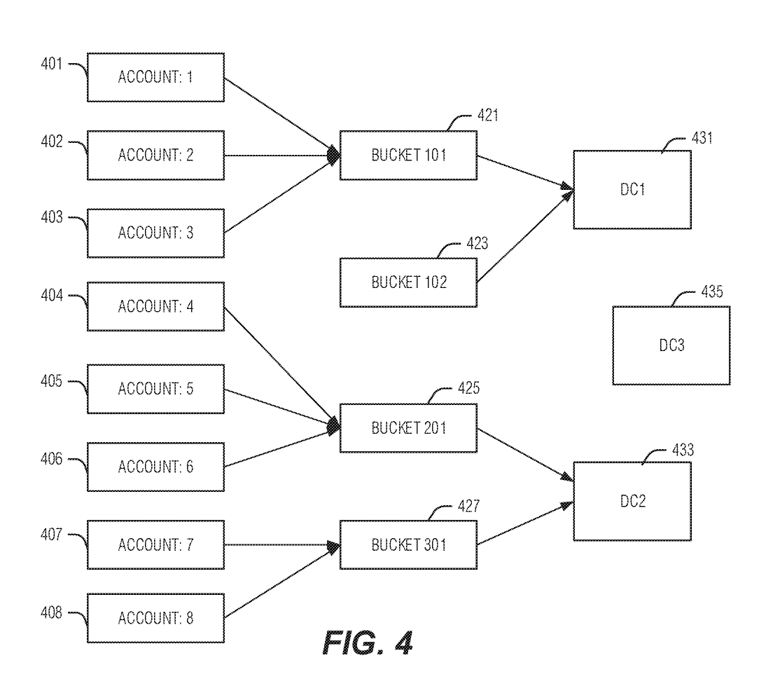

Referring now to FIG. 4, an entity assignment may be performed in two levels. An entity may be assigned to a bucket and a bucket may be assigned to a data center. This allows for quicker load balancing of larger groups at one time, i.e., groups of entities at a time rather than a single entity, based on bucket assignment. For instance, in an embodiment, entities may be associated with accounts or contracts with the provider. In this example, there are shown accounts 1-8 (401-408, respectively). Accounts 1-3 may be assigned to bucket 101 (421) Accounts 4-6 may be assigned to bucket 201 (423). Accounts 7 to 8 may be assigned to bucket 301 (427). Buckets 421 and 423 may be assigned to data center DC1 431. Buckets 425 and 427 may be assigned to data center DC2 433. In this example no accounts are assigned to bucket 423. And no accounts or buckets are assigned to data center DC3 435.

Referring again to FIG. 3, in an embodiment, data store 322 may be a lightweight non-relational database, for quicker access, although it will be understood that various database schemas could be used. The data store 322 holds information relating to which cluster or bucket an entity is assigned. In an embodiment, an entity may be assigned a uniform resource name (URN) as an identifier. The URN identifies the entity in a request. One example is urn:li:contract:1234 which refers to a member contract, or urn:li:member:4567, which refers to a member account. The routing considers a different entity URN for different application context, for example. The user or member may be routed differently based on the URN which identifies the user, contract, account, or service. Each entity type may have its own table in database 322. The tables may be conceptually a hash map that maps an entity URN to a string. For instance one table may map account entities to a bucket, e.g., account 1 (401) to bucket 101 (421). Another table may map the bucket entities to the data center, e.g., bucket 101 (421) to DC1 431.

Regardless of which data center receives the user request based on member routing data, the entity specific requests need to be routed to the data center where the entity is “hosted” for both read and write operations. If the entity's data center is down, for instance, for maintenance, there may be a simple fail over mechanism for entities hosted in that the data center that failed. Those entities may be assigned to another data center, at least temporarily. Reassigning an entity to a different data center for load balancing, geographic hosting requirements, or due to an outage, can be effected with minimal interruptions, and user access to services hosted by the new data center may be easily effected by modifying the entity routing relationships in data store 322. Typically, an application service instance will run in each data center, and data mirrored at other data centers using various methods. However, the entity routing relationships force user requests to be serviced in the same data center for all members of the entity. If the selected data center becomes overloaded, down for maintenance, or geographically undesirable to the entity, the routing information may be modified to associate the entity with a different data center by either reassigning it to a different bucket; or reassigning the associated bucket to a different data center. In this way, members still access data for the application service at the same data center.

In an embodiment, a quick entity traffic shift report may be run for a batch or chunk of traffic on one data center, for instance at service 334. The results of this traffic report may indicate that entities should be partitioned into slightly different buckets where some of the buckets are mapped to a different data center.

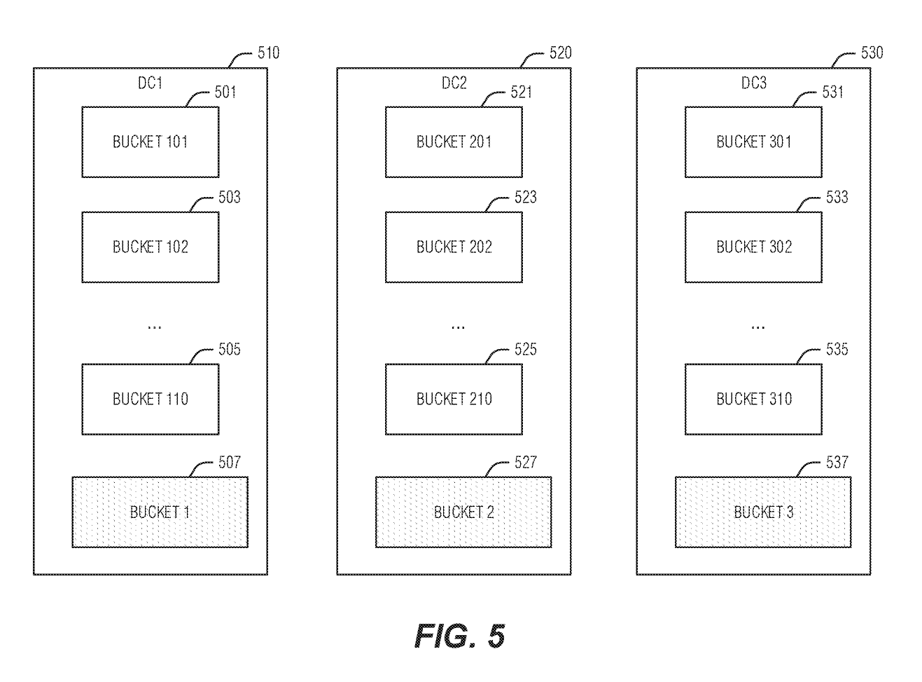

Referring now to FIG. 5, there is shown an example distribution of buckets within a number of data centers, according to an embodiment. Each data center may contain N+1 buckets. The data centers may be identified numerically as DC1 510, DC2 520, DC3 530, etc. In this example, the highest digit of the bucket's number (1, 2 or 3 in this example) is the data center ID. For instance DC1 510 would contain bucket 101 (510), bucket 102 (503), . . . , bucket 110 (505), and also a bucket with only the data center numerical ID, e.g., bucket 1 (507). Similarly, DC2 520 may include bucket 201 (521), bucket 202 (523), . . . , bucket 210 (525), and bucket 2 (527). And finally, DC3 530 may include bucket 301 (531), bucket 302 (533), . . . , bucket 310 (535), and bucket 3 (537).

In an embodiment, bucket 1 (507), bucket 2 (527), and bucket 3 (537) may be considered as special pinned bucket that may not be shifted to another data center. For instance, a corporation may require that its data reside in the U.S. or Europe for privacy concerns, or Singapore for tax purposes. In these cases, the entity relationship with respect to a certain application service or data may be pinned to a specific data center or geographic location, via a pinned bucket. In some cases, an organization may require only one account, or application service data to be pinned. Therefore, members of the organization may be reasonably associated with multiple entities, buckets and data centers.

In an embodiment, when an account for one or more application services is created, thereby creating a de facto entity, the entity may be assigned to a bucket in the data center where it was created initially. An off-line traffic analysis job may compute the optimal assignment and uses calculation to reassign entities to different data centers on a regular basis. In addition, an entity may be reassigned on demand. For instance if a customer has issues about latency or lag, it may be determined that the entity is assigned to the wrong data center and will be reassigned, upon request. Entity assignment may be achieved by updating the entity assignment table in the data store 322. For an on demand reassignment, the entity may be assigned to a pinned bucket, as discussed above regard to FIG. 5.

Entity assignment may move one entity. An entity shift may move a chunk or portion of entities at one time. An entity shift may be achieved by reassigning an entire bucket at to a new data center. To effect the entity shift, the bucket assignments table in the data store 322 would be modified.

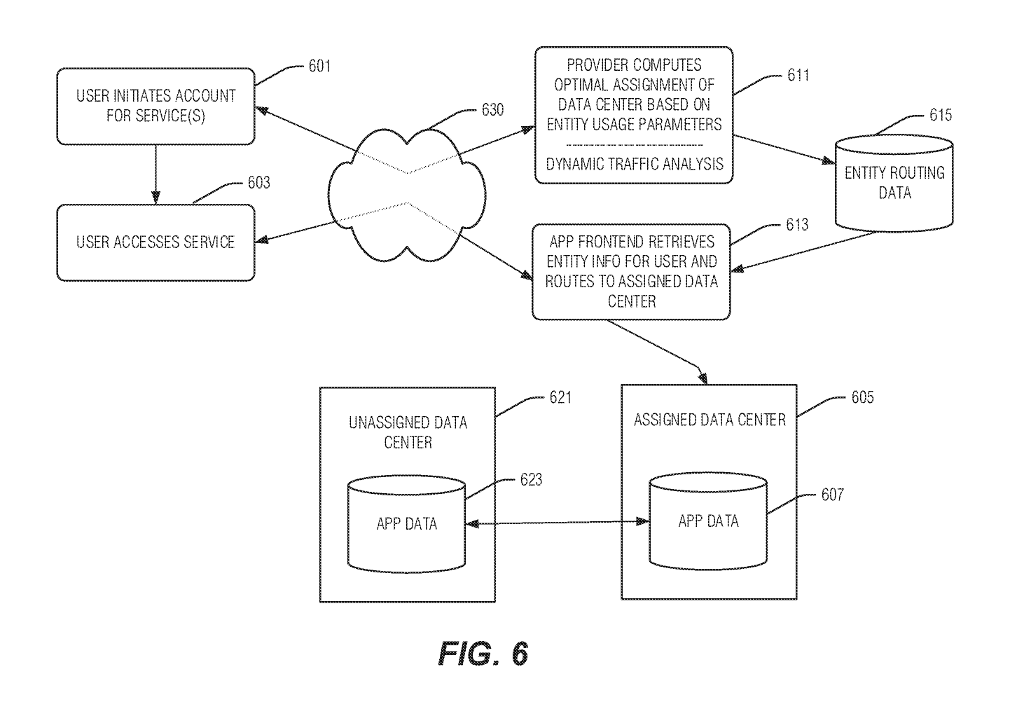

Referring to FIG. 6, there is shown a simplified flow diagram for entity routing, according to an embodiment. A user opens a new account or requests an application service (“service”) from a provider at block 601. The request is typically sent to the provider via a network 630. The provider computes an initial optimal data center assignment for the entity or collection of sub-entities, based on parameters in the request at block 611. This may be as simple as selecting the data center in closest proximity to the user making the request. In an embodiment, the initial data center may be selected based on current loads of some or all available data centers. In another embodiment, the user may request an initial data center along with the application service request, and optionally select an acceptable secondary data center. The entity, bucket and data center assignments are recorded in a data store 615. The initial assignment may depend on which services are requested, and the geo-location of the organization or individual opening the account. If the account initiation is a request for more than one service, the provider may create multiple entities or sub-entities that associate each entity with a different group of users within the organization and with one or more of the requested services. In an example, a single organization may be assigned two entities, one for service A and one for service B. Based on an initial estimate of number of users requiring the services, their locations, and usages and traffic already existing at the data centers, the two entities may be assigned different data centers, one for each service. Different entities, for instance, may be assigned to different data centers for different services, but exist in the same organization. And different organizations, may be assigned to the same data center, or different data centers. In an example, each application service may run in all data centers, and the data center assigned to various entities using the same service may change over time. Once the initial assignment is recorded in the entity routing data store 615, a user's service requests are routed by the frontend 613, as described above, to the assigned data center 605.

The entity assignment process may be re-executed at periodic intervals, on request, or dynamically to include traffic analysis and other criteria for updating the optimal data center. Criteria may include actual member traffic patterns for location, peak times, other data center availability, service level agreement requirements, etc. If assignments change, the entity routing data store 615 is updated, and relevant hosted application data may be migrated to another data center. In an example, the user or entity is initially assigned to assigned data center 605. Application data for hosted services for this entity will be primarily stored in the assigned data center application data store 607. An unassigned data center 621 may be available to the provider, and has its own data store 623. In an embodiment, application data 623 mirrors data in application data store 607. There may be some delays, however, in accessing and updating data in mirrored data stores, depending on to which frontend a user was routed during the initial service request, and how often the data mirroring processes are executed.

The databases may be synchronized across data centers via a standard replication protocol. For instance, replication may be effected by Oracle or MySQL mirroring/replication protocols. Protocols using DataBus or Kafka messaging or other data replication tools may be used, as well. Any database replication mechanism would work to mirror the data. In an embodiment, the data is replicated at the backend in the data centers.

When a user or entity accesses the contracted service in block 603, an application frontend on the provider side receives the request and identifies the entity by retrieving the routing information from the data center's local copy of the entity routing data store, at block 613. Identification may be based on a login id, or the service being requested, or merely location of the requestor. The entity status of the user may be sent as a cookie with the request. The application frontend may retrieve the entity based rules from the entity routing data store 615 to identify the entity URN. The entity URN is then used to route the request directly to the frontend at the correct data center.

In an example, the entity member may be proximately closer to the unassigned data center 621. Under existing systems this would cause the entity to connect to the service at this data center. However, each request would require additional handshaking and routing with the application backend at the hosted, or assigned, data center 605, resulting in inefficiency. By moving the routing decision to the frontend, inefficiencies in network re-routing may be avoided.

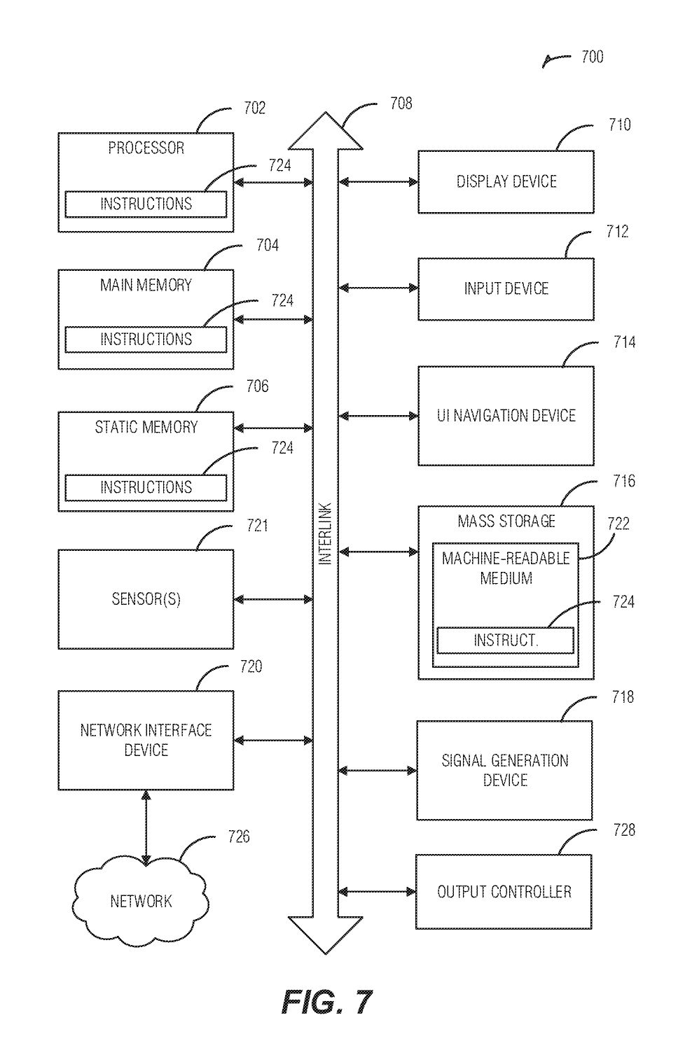

FIG. 7 illustrates a block diagram of an example machine 700 upon which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant particles having mass, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse, track ball, etc.). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

In an embodiment, a user or entity accesses the provided application from an instance of machine 700, via a network 726 to another instance of machine 700. It will be understood that the machine used by the entity may be different in architecture than the provider's machine(s), which are typically servers having routing capability, and within one or more data centers.

### ADDITIONAL NOTES AND EXAMPLES

Examples can include subject matter such as a method, means for performing acts of the method, at least one machine-readable medium including instructions that, when performed by a machine cause the machine to performs acts of the method, or of an apparatus or system for entity-based routing in a network and between data centers, according to embodiments and examples described herein.

Example 1 is a system for routing entities, comprising: an entity routing service coupled to an entity routing database to store information to identify relationships among a plurality of entities and a plurality of data centers, wherein the entity routing database is further to store information to identify an access route for an application service based at least on entity routing relationship information retrieved from the entity routing database, and a first frontend application server residing in a first data center of the plurality of data centers, the frontend application server communicatively coupled to the entity routing service, and to receive the entity routing relationship information from the entity routing service, and further to route user requests directly to a second frontend application server at a second data center of the plurality of data centers when the second data center is to host application services requested by a user associated with at least one entity.

In Example 2, the subject matter of Example 1 optionally includes wherein the relationships among the plurality of entities is further defined by each entity associated with a routing bucket, where the associated routing bucket is associated with a specific data center.

In Example 3, the subject matter of Example 2 optionally includes wherein the access route for the application service is based on a determination of the specific data center associated with the routing bucket, the routing bucket assigned to the specific data center based at least on whether the specific data center is to host the application service requested by the entity.

In Example 4, the subject matter of any one or more of Examples 1-3 optionally include wherein each entity of the plurality of entities is associated with a routing bucket of a plurality of routing buckets, and wherein each routing bucket of the plurality of routing buckets is associated with a data center of the plurality of data centers.

In Example 5, the subject matter of Example 4 optionally includes wherein the user associated with at least one entity is assigned a first entity based on usage requirements for a first application service, wherein the access route for the first entity is to a first routing bucket assigned to a first data center, and wherein the first routing bucket is assigned to both the first application service and the first entity.

In Example 6, the subject matter of Example 5 optionally includes wherein the user is further assigned a second entity based on usage requirements for a second application service, wherein the access route for the second entity is to a second routing bucket assigned to a second data center, and wherein the second routing bucket is assigned to both the second application service and the second entity.

In Example 7, the subject matter of Example 6 optionally includes wherein the first routing bucket is one of a same or different routing bucket as the second routing bucket, and wherein the first data center is one of a same or different data center as the second data center.

In Example 8, the subject matter of any one or more of Examples 5-7 optionally include wherein responsive to change in the access route for the first entity for the first application service, from the first routing bucket to a second routing bucket, communication from the first entity to the first application service is routed to a frontend server at a data center associated with the second routing bucket.

Example 9 is an entity routing service comprising: a processor coupled to an entity routing database, the processor to communicate with an application frontend server in a first data center, the processor having memory storing instructions to: responsive to a user request to an application service, retrieve entity information associated with the user request, based on the application service; and provide an access route for the user request to the application frontend server in the first data center, wherein the access route includes information to enable the application frontend server in the first data center to route the user request to a predefined application frontend server associated with a second data center.

In Example 10, the subject matter of Example 9 optionally includes wherein the user request comprises information identifying a user sending the request and the requested application service, and wherein the entity routing database is to store information correlating the user and requested application service with an entity identification.

In Example 11, the subject matter of Example 10 optionally includes wherein the information identifying a user sending the request the requested application service are provided by a cookie.

In Example 12, the subject matter of any one or more of Examples 10-11 optionally include wherein the information correlating the user and requested application service is further correlated with a routing bucket associated with a data center.

In Example 13, the subject matter of Example 12 optionally includes wherein the application frontend server in the first data center is to use the routing bucket information to route the user request to the predefined application frontend server associated with a second data center.

In Example 14, the subject matter of Example 13 optionally includes wherein the first data center is the same as the second data center.

In Example 15, the subject matter of any one or more of Examples 13-14 optionally include wherein the user request is routed to the predefined application frontend server in the second data center with enough information to be processed by a backend application server at the second data center and communicatively coupled to the predefined application frontend server.

In Example 16, the subject matter of any one or more of Examples 14-15 optionally include wherein the application frontend server in the first data center is a different physical server than the predefined application frontend server in the first data center.

In Example 17, the subject matter of any one or more of Examples 12-16 optionally include instructions to: modify the access route for the user request in the entity routing database based on a change in relationship status between the entity identification and the routing bucket associated with the second data center.

Example 18 is an entity routing service comprising: a processor coupled to an entity routing database, the processor to communicate with an application frontend server in a first data center; means for retrieving entity information associated with a user request, based on the application service, responsive to the user request to an application service; and means for providing an access route for the user request to the application frontend server in the first data center, wherein the access route includes information to enable the application frontend server in the first data center to route the user request to a predefined application frontend server associated with a second data center.

In Example 19, the subject matter of Example 18 optionally includes wherein the user request comprises information identifying a user sending the request and the requested application service, and wherein the entity routing database is to store information correlating the user and requested application service with an entity identification.

In Example 20, the subject matter of Example 19 optionally includes wherein the information identifying a user sending the request the requested application service are provided by a cookie.

In Example 21, the subject matter of any one or more of Examples 19-20 optionally include wherein the information correlating the user and requested application service is further correlated with a routing bucket associated with a data center.

In Example 22, the subject matter of Example 21 optionally includes wherein the application frontend server in the first data center is to use the routing bucket information to route the user request to the predefined application frontend server associated with a second data center.

In Example 23, the subject matter of Example 22 optionally includes wherein the user request is routed to the predefined application frontend server in the second data center with enough information to be processed by a backend application server at the second data center and communicatively coupled to the predefined application frontend server.

In Example 24, the subject matter of any one or more of Examples 21-23 optionally include means for modifying the access route for the user request in the entity routing database based on a change in relationship status between the entity identification and the routing bucket associated with the second data center.

The techniques described herein are not limited to any particular hardware or software configuration; they may find applicability in any computing, consumer electronics, or processing environment. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, smart phones, mobile Internet devices, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments, cloud environments, peer-to-peer or networked microservices, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

Examples, as described herein, may include, or may operate on, circuitry, logic or a number of components, modules, or mechanisms. Modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured, arranged or adapted by using software, the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill in the art upon reviewing the disclosure herein. The Abstract is to allow the reader to quickly discover the nature of the technical disclosure. However, the Abstract is submitted with the understanding that it will not be used to interpret or limit the scope or meaning of the claims.

What is claimed is:

1. A system for routing entities, comprising:
an entity routing service coupled to an entity routing database to store information to identify relationships among a plurality of entities and a plurality of data centers, wherein the entity routing database is further to store information to identify an access route for an application service based at least on entity routing relationship information retrieved from the entity routing database, and
a first frontend application server residing in a first data center of the plurality of data centers, the frontend application server communicatively coupled to the entity routing service, and to receive the entity routing relationship information from the entity routing service, and further to route user requests directly to a second frontend application server at a second data center of the plurality of data centers when the second data center is to host application services requested by a user associated with at least one entity.

2. The system as recited in 1, wherein the relationships among the plurality of entities are further defined by each entity associated with a routing bucket, where the associated routing bucket is associated with a specific data center.

3. The system as recited in claim 2, wherein the access route for the application service is based on a determination of the specific data center associated with the routing bucket, the routing bucket assigned to the specific data center based at least on whether the specific data center is to host the application service requested by the entity.

4. The system as recited in claim 1, wherein each entity of the plurality of entities is associated with a routing bucket of a plurality of routing buckets, and wherein each routing bucket of the plurality of routing buckets is associated with a data center of the plurality of data centers.

5. The system as recited in claim 4, wherein the user associated with at least one entity is assigned a first entity based on usage requirements for a first application service, wherein the access route for the first entity is to a first routing bucket assigned to a first data center, and wherein the first routing bucket is assigned to both the first application service and the first entity.

6. The system as recited in claim 5, wherein the user is further assigned a second entity based on usage requirements for a second application service, wherein the access route for the second entity is to a second routing bucket assigned to a second data center, and wherein the second routing bucket is assigned to both the second application service and the second entity.

7. The system as recited in claim 6, wherein the first routing bucket is one of a same or different routing bucket as the second routing bucket, and wherein the first data center is one of a same or different data center as the second data center.

8. The system as recited in claim 5, wherein responsive to change in the access route for the first entity for the first application service, from the first routing bucket to a second routing bucket, communication from the first entity to the first application service is routed to a frontend server at a data center associated with the second routing bucket.

9. An entity routing service comprising:
a processor coupled to an entity routing database, the processor to communicate with an application frontend server in a first data center, the processor having memory storing instructions to:
responsive to a user request to an application service, retrieve entity information associated with the user request, based on the application service; and
provide an access route for the user request to the application frontend server in the first data center, wherein the access route includes information to enable the application frontend server in the first data center to route the user request to a predefined application frontend server associated with a second data center.

10. The entity routing service as recited in claim 9, wherein the user request comprises information identifying a user sending the request and the requested application service, and wherein the entity routing database is to store information correlating the user and requested application service with an entity identification.

11. The entity routing service as recited in claim 10, wherein the information identifying a user sending the request the requested application service are provided by a cookie.

12. The entity routing service as recited in claim 10, wherein the information correlating the user and requested application service is further correlated with a routing bucket associated with a data center.

13. The entity routing service as recited in claim 12, wherein the application frontend server in the first data center is to use the routing bucket information to route the user request to the predefined application frontend server associated with a second data center.

14. The entity routing service as recited in claim 13, wherein the first data center is the same as the second data center.

15. The entity routing service as recited in claim 13, wherein the user request is routed to the predefined application frontend server in the second data center with enough information to be processed by a backend application server at the second data center and communicatively coupled to the predefined application frontend server.

16. The entity routing service as recited in claim 14, wherein the application frontend server in the first data center is a different physical server than the predefined application frontend server in the first data center.

17. The entity routing service as recited in claim 12, further comprising instructions to:
modify the access route for the user request in the entity routing database based on a change in relationship status between the entity identification and the routing bucket associated with the second data center.

18. An entity routing service comprising:
a processor coupled to an entity routing database, the processor to communicate with an application frontend server in a first data center;
means for retrieving entity information associated with a user request, based on the application service, responsive to the user request to an application service; and
means for providing an access route for the user request to the application frontend server in the first data center, wherein the access route includes information to enable the application frontend server in the first data center to route the user request to a predefined application frontend server associated with a second data center.

19. The entity routing service as recited in claim 18, wherein the user request comprises information identifying a user sending the request and the requested application service, and wherein the entity routing database is to store information correlating the user and requested application service with an entity identification.

20. The entity routing service as recited in claim 19, wherein the information identifying a user sending the request the requested application service are provided by a cookie.

21. The entity routing service as recited in claim 19, wherein the information correlating the user and requested application service is further correlated with a routing bucket associated with a data center.

22. The entity routing service as recited in claim 21, wherein the application frontend server in the first data center is to use the routing bucket information to route the user request to the predefined application frontend server associated with a second data center.

23. The entity routing service as recited in claim 22, wherein the user request is routed to the predefined application frontend server in the second data center with enough information to be processed by a backend application server at the second data center and communicatively coupled to the predefined application frontend server.

24. The entity routing service as recited in claim 21, further comprising means for modifying the access route for the user request in the entity routing database based on a change in relationship status between the entity identification and the routing bucket associated with the second data center.
